(19) United States
(12) Patent Application Publication
(10) Pub. No.: US 2011/0122245 A1
(43) Pub. Date: May 26, 2011

(54) FOREST FIRE CONTROL SYSTEMS (FFiCS) WITH SCANNER AND OPTICAL /INFRARED RADIATION DETECTOR (SOIRD) AND OPTIONALLY ALSO INCLUDING A SCANNER WITH ACCURATE LOCATION CALCULATOR (SALC) AND A SUPER-EFFICIENT SATELLITE/WIRELESS ANTENNA SYSTEM (SSWAS)

(76) Inventor: ASHOK KUMAR SINHA, Ypsilanti, MI (US)

(21) Appl. No.: 12/623,461

(22) Filed: Nov. 23, 2009

(51) Int. Cl. G08B 17/00; G08B 1/08; H04N 7/18; G01S 19/42

(52) U.S. Cl. 348/143; 340/577; 340/532; 342/357.25

(57) ABSTRACT

This application for patent for Forest Fire Control Systems (FFiCS) describes an invention for prevention and control of forest fires (FF). The system comprises strategically located Ignition Detection and Uplink Signaling Towers (IDUSTs), equipped with the Global Positioning System (GPS) and a suitable optical/infrared Scanner and Detector Assembly (SDA), to continually scan the forest region to instantly detect the onset of the initial flames and sparks of any fire (f/s) within the region. The SDA may optionally utilize a Scanner and Accurate Location Calculator (SALC). Upon detecting an f/s, the IDUST instantly transmits relevant data to a Regional Forest Fire Control System (RFFCC) via a suitable communications means, optionally utilizing the Super-Efficient Satellite and Wireless Antenna System (SSWAS). The RFFCC instantaneously transmits necessary information to area Forest Fire Control Field Stations (FFCFS), enabling them to immediately apply appropriate fire-quenching means to control the fire before it spreads.

### 1. FIELD AND SUMMARY OF THE INVENTION

The present invention and application thereof relate to the problem of forest fire (FF) and to a viable solution toward early detection and control, to prevent loss of life and property and damage to the environment. Thus the key element or the basic feature of the present invention is early detection of the occurrence or onset of FF, and the determination of its exact geographical location, together with automatic, efficient and instantaneous transmission of the essential information and data (pertaining to the exact location and time of such an occurrence, and other related weather-report.) This information permits effective control of the FF by conventional and innovative means. In summary, the key ingredient of the invention, allowing an early enough detection of the forest fire, almost at the very start of the occurrence thereof, include:

IDUST performing continuous monitoring;

SCAD assembly comprising scanner and visible-range and/or infrared detector;

ALC providing the determination of the precise location (and time);

SSWAS for efficiently transmitting the pertinent information (and other data); and

RFFCC receiving the data and activating means of fire control instantly.

The above type of FFiCS almost guarantees the earliest possible detection and relatively an easy prevention and control of the forest fire before it has a chance to spread around or escalate, when fighting and controlling the fire becomes an arduous or nearly a hopeless task. It can hardly be overemphasized that early detection and control is the essence of successful fire-fighting and protection of lives and propertied. This can be made possible in practice by means of the system described in this application.

### 2. DESCRIPTION OF THE PRIOR ART

Apart from causing tragic loss of lives and valuable natural, national and individual properties including hundreds and thousands of acres of forest and hundreds of houses, forest fires are a great menace to ecologically healthy grown of forests and protection of the environment. Every year, many forest fires in different parts of the country and the world cause disasters beyond measure and description. Examples of a few recent forest fires and the resulting disastrous impacts thereof, can be seen in many a the news report of the Associated Press Reports (AP-R) and many other media reports and stories. An AP-R dated Oct. 5, 2009, for instance, describes a fire in the San Bernadino National Forest, CA, that burned 3500 acres of the forest and also several houses. More than 500 fire fighters found hard to control it, partly due to the strong 72 km/hr wind that whipped it. In August 2009, forest fires wreaked havoc in Greece (3700 acres, 100s of houses). There was also a terrible fire in Greece (in 2007); in Spain (smoke spreading over 700 km); and in Canada and Australia. As recently as Nov. 21, 2009, in Tasmania, Australia, a horrible forest fire has been reported. Some of the fires could be natural disasters or directly or indirectly the product of human negligence and abuse of the environment (including the rise of temperature associated with the global warming.)

Unfortunately, the forest fire is commonly observed only when it has already spread over a large area, making its control and stoppage arduous, and often even nearly impossible. The result is a devastating loss of lives (of fire-fighter crewmen and others) and property (valuable forest foliage and resources as well as clusters of houses and other buildings in the outlying areas), in addition to irreparable damage to the ecology (huge amount of smoke and carbon-dioxide (CO₂) in the atmosphere. Among other terrible consequences of FF are such long-term disastrous effects as impact on the local weather pattern; global warming; extinction of rare species of the flora and fauna; etc. Typically, fire-fighting crew and equipment are dispatched upon receiving news of occurrence of FF: the fire usually becomes widespread by that time. Apart from land-based assault on the fire to control and to arrest its further spread, air-borne helicopters are employed to drop fire-retardant chemicals and materials (e.g., high-power water-spray, liquid nitrogen, purple K dry chemical, Potassium-Biocarbonate mixture, dynamite explosives, etc.), although often such means of fire-fighting remains inadequate in controlling the fire due to the large area that becomes engulfed by the fire before the arrival of the helicopter(s) or ground-crew. Due to a large amount of fumes and smoke, the life of the helicopter-pilot and the very operation remain at risk; and their survival and success can be in jeopardy.

Some additional examples of FF and related damages, representing the current state of affairs as well as the current state-of-the-art of fighting FF can be seen in the websites of the California State Department of Forest (http://ww fire.ca.gov/) and of the US Department of Agriculture, Forest Service Division (http://www.fs.fed.us). A large number of press-reports and press-releases, too numerous to cite references of, also bear testimony to the havoc and disastrous losses caused by FF almost every year. A recent news-release, for instance, can be seen at the URAL (dated Oct. 4, 209):

http://news.yahoo.com/s/ap/20091004/ap_on_re_us_/us_wildfires

This Associated Press (AP) news-release refers to the so-called ‘Sheep fire’ that “charred some 5½ square miles (over 3500 acres) of the San Gabriel Mountains . . . destroyed three homes and was (only) 10 percent surrounded . . . . Between 4000 and 6000 residents were ordered to evacuate . . . the winds (with gusts of up to 40 mph) are quite a problem . . . helicopters and air tankers . . . aided by about 1000 firefighters on the ground . . . making a stand in the mountain resort community (containing a mix of full-time residences and vacation homes), spreading fire retardant gel to structures to protect them from advancing flames . . . .” The same news-release also mentions another forest fire in Arizona (the ‘Twin Fire’) resulting from a “‘prescribed burn that grew out of control (and) threatened the town known as the ‘Gateway to the Grand Canyon’ . . . (and had) scorched about 1000 acres, or more than 1½ square miles . . . burning forest undergrowth and ponderosa pines on Bill Williams Mountain.” The scale of FF-related devastation as well as the typical fire-fighting effort and activity, reflecting the current state-of-the-art of fighting FF, is fairly well represented by this news-release and many similar one frequenting the press. It is rather obvious that the current state-of-the-art means for preventing, controlling and fighting forest fires are far from satisfactory, since a satisfactory means of fighting FF should be able to control and eliminate FF to a large extent, without incurring such terrible devastations and losses that the incidents of FF cited in most of the reports contained in these web sites depict. One key element involved here is the lack of means to detect FF at the very inception thereof; typically a FF is reported when it has already spread over a large area, or assumed a nearly uncontrollable size and proportions. This is the deficiency that the present Invention attempts to remedy, by means of detection of a FF at the very early stage (i.e., when it is in the f/s phase), so as to enhance or ensure the chance to put it out before it has grows beyond control or causes any significant damage.

Recently, Earth-orbiting satellites and even air-floating devices have been employed for observation and detection of FF. Any existing satellite-based observations for FF suffer from severe limitations resulting in a failure in speedy and effective control of the same. Some of the limitations in an approach based on direct observation of FF from an orbiting geostationary (GEO) or Low-Earth-Orbit (LEO) satellite are as follows:

(i) The satellite coverage of the full region of the forest may not be available; or the coverage (by a LEO satellite) may be only intermittent (not continuous in time), with substantial gaps in time when the satellite is not within the field of view from certain regions or spots of the forest.

(ii) The optical (visible) and the infrared (heat) spectral radiation emitted by a small flame, the early phase of a FF prior to its spread over a wide region, may be too feeble in intensity to be detected by a satellite. It must be recalled that a geostationary satellite is at an altitude of 22,800 miles above the surface of the earth, and a LEO satellite is typically also many hundreds or thousands of mile above the earth's surface; and the intensity decreases as the inverse square of the distance, in addition to being sensitive to the angle between the direction of the arriving beam of radiation and the normal to the receiving surface—mirror, camera, antenna, detector (Lambert's Law); so that position and orientation of the satellite may usually be far from optimal for detecting a FF at an early phase.

(iii) The satellite, even if it is of the remote-sensing type, may not be equipped with transponder(s) and antenna(s)—the component(s) designed to perform the reception, amplification, regeneration, frequency-translation and downlink-transmission to the ground—optimally suited for detection of forest fires. In fact; there may not yet be formal allocation of the appropriate frequency and bandwidth for FF detection and pertinent information transmission and processing (onboard or at the ground terminal or earth station). All these factors make it difficult to accurately pin-point the location and time of the onset of the fire and to instantaneously prepare and deploy measures to fight the FF.

(iv) A satellite is usually designed to perform many diverse functions (telecommunications, remote-sensing for broad features of the earth's surface or the atmosphere, etc.) and it is not cost-effective to add to it the capability to detect FF.

(v) The operation of a satellite system may not be real-time in order to instantaneously provide information about the onset or occurrence of a FF anywhere within the forest region.

(vi) The operation of a satellite system is bound by many national and international regulations and agreements, and may be less than suitable for the task of FF observation.

The present invention and the proposed system will be shown to overcome all of the above limitation, while retaining the especial advantages of a satellite telecommunications in terms of wide (regional, national, international or global) geographical coverage(s) and instantaneous information transmission accurately. This is accomplished by separating the FF observation or remote-sensing function from the telecommunications function and devising a special new devices to perform these (remote-sensing and information transmission) functions more directly, accurately and efficiently. This is accomplished by means of a scanner-sensor-location calculator assembly (SALC) which, on being activated by a FF (at its early phase, prior to its spread to a bigger size or over a larger area), generates the necessary data to be sent via the telecommunications satellite or wireless link, using a most efficient antenna system (SSWAS) to a regional FF fire control center (RFFCC) prompting for immediate action.

The present Application for prevention and control of FF employs, among other components, the critically important components identified as SALC and SSWAS above. These components are vital for the accuracy and economy of the installation and operation of the FFiCS system proposed here, and are described below in more detail. However, it must be recognized that each of these devices can and should also be considered as inventions in their own right, and can be employed in systems other than FFiCS. Examples of such applications include accurate location determination systems subject to a GPS-assisted observation base (for SALC); and any telecommunications system where reflector antennas are used (for SSWAS) including usual satellite and wireless telecommunications systems. It should also be emphasized here that, as is well-known, in many cases many of the functions of a telecommunications (GEO or LEO) satellite may be equally well served by a terrestrial mobile (cellular) telephone network(s). Accordingly, in the present application for patent, it is assumed throughout that, even if only a satellite system or network is mentioned, a mobile (cellular) terrestrial system or network could be equivalently applied or employed in place of, or in addition to, the mentioned satellite system or network. Thus this Application equivalently and interchangeably covers both types of systems (satellite and terrestrial mobile) as regards the telecommunications link from the IDUST to the RFFCC, and between the RFFCC and the fields stations and vehicles for fire control.

### 3. BRIEF DESCRIPTION OF THE SYSTEM COMPONENTS AND DRAWINGS

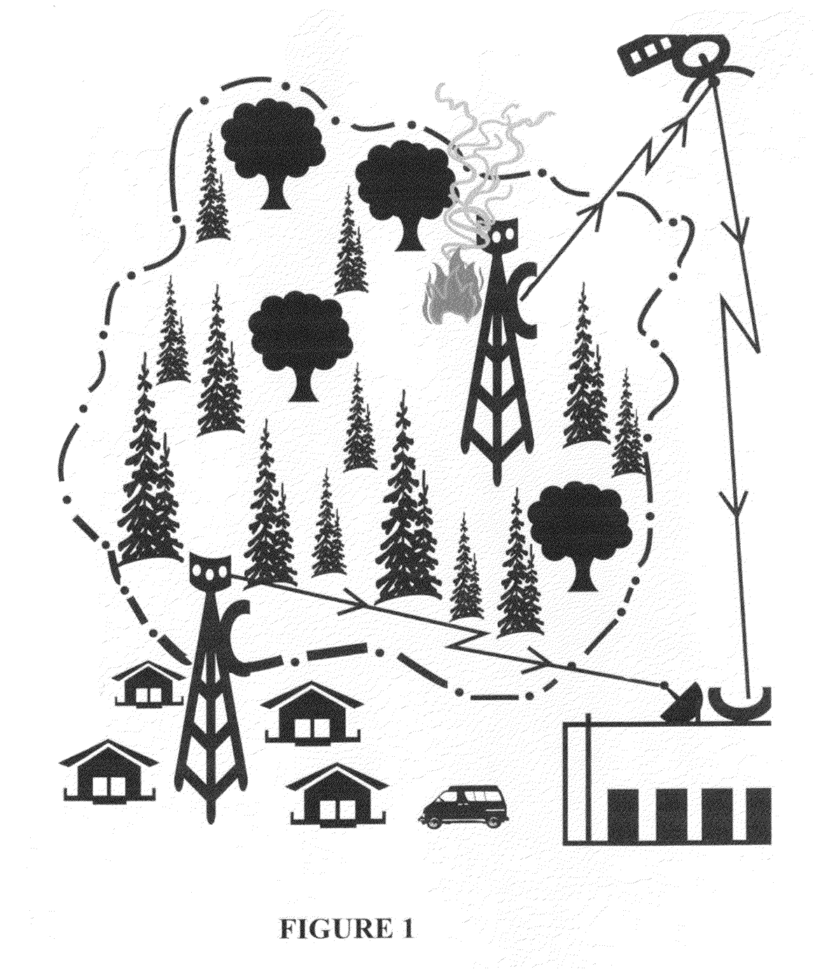

The general overview of the Forest Fire Control System (abbreviated here as ForeFiCS, or simply as FFiCS) is schematically depicted in FIG. 1, where the specified letters and notations symbolically represent the subsystems and components as described below:

F: The forest region to be monitored and protected against Forest Fire (FF);

H: Residential and other sensitive areas to be especially protected against FF;

T: The Ignition Detection and Uplink Signaling Tower (IDUST);

S: The GEO or LEO satellite with telecommunications facility for FF;

W: Wireless network transceiver for telecommunications, as necessary;

R: Regional Forest Fire Control Center (RFFCC);

N: Forest Fire Control Field Station(s) (FFCFS);

f/s: The spot where the initial flames/smoke/spark of the FF occurs;

S_{L}: The IDUST-to-satellite-to-RFFCC telecommunications (data-transfer) link;

W_{L}: The wireless IDUST-to-RFFCC link.

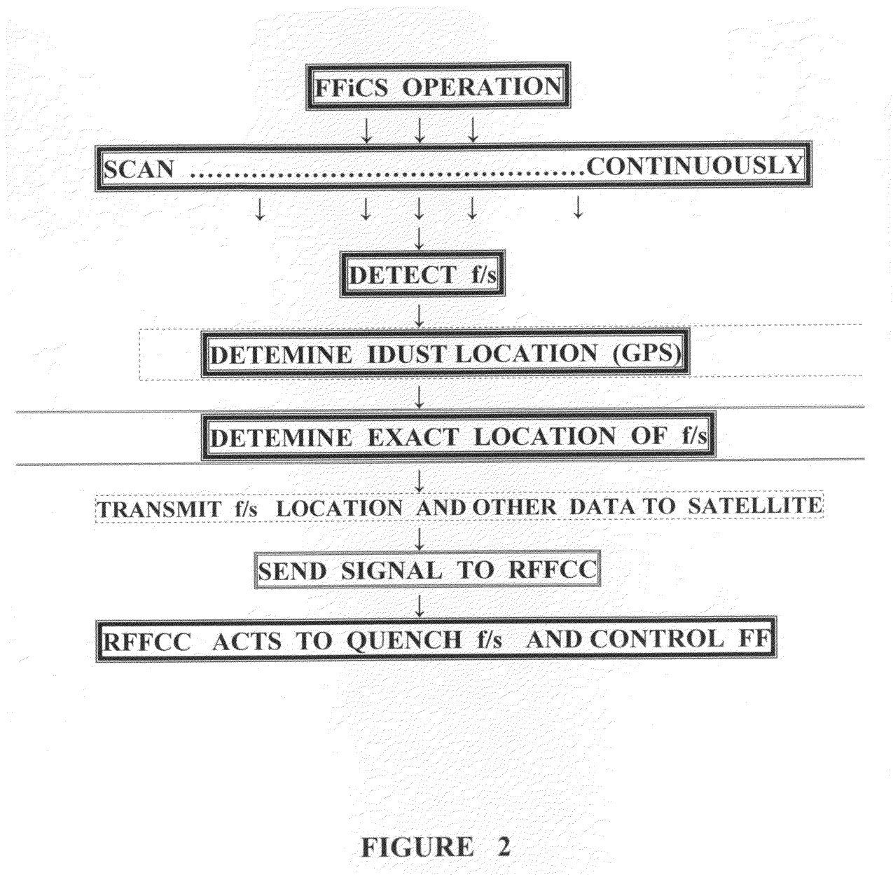

The general sequence of events and operations in the process of FF detection and control is schematically represented in FIG. 2, comprising the following steps (in the order listed):

(1) A tree or a bush, or a small set of neighboring trees and/or bushes, in the forest {denoted by the letter ‘F’} catches fire and exhibits a small flame(s), smoke and sparks {f/s};

(2) The scanner-detector assembly mounted on a suitably located IDUST {T} detects the f/s and instantly determines its exact location (longitude, latitude), using the SALC subsystem as well as the precise time of this occurrence;

(3) The satellite and/or wireless link is activated for an ‘uplink’ transmission of the f/s and other weather-related pertinent data (temperature, wind-direction and speed, etc.) to the GEO or LEO satellite {S} and/or a wireless network tower {W} with the help of the SSWAS subsystem;

(3) The satellite or wireless tower instantly relay this information to the Regional Forest Fire Control Center (RFFCC) {R};

(4) The RFFCC immediately alerts and activates all Forest Fire Control Field Stations (FFCFS) (N1, N2, N3, . . . , not shown in FIG. 1) which dispatch their forest fire control crew, vehicles including helicopters, equipment, and materials to quench and control the fire before it has time to grow by consuming a larger section of the forest, or to threaten neighboring or outlying residential area(s) {H}, or to cause any appreciable loss or damage.

It must be reiterated here that time is of essence in the fire fighting process in general, and the present invention, recognizing this fact, is designed to cut short the time between the moment of onset of fire and the efforts to control it to a bare minimum, making use of the following features:

(A) Immediate, real-time detection of a FF by detecting the very initial f/s;

(B) Accurate determination of the exact spot of occurrence of the FF, making use of the Scanner and Accurate Location Calculator (SALC) subsystem;

(C) Instantaneous information transmission to the RFFCC, via a satellite and/or wireless link, making use of the Super-Efficient Satellite and Wireless Antenna System (SSWAS);

(D) Alerting and activating, within a fraction of a second from the occurrence of the very initial flame/smoke/sparks (f/s), the Regional Forest Fire Control Center (RFFCC) and all members of the FFCFSs, with detailed information of the exact location, within a few feet, of the occurrence of the f/s, helping to quench the fire before it spreads over an appreciable area or assumes a larger proportion difficult to control, thereby causing much losses and damages.

It should also be understood that the above description of the systems and subsystems structure and functions is generic and variations to suit specific regional features, conditions and circumstances are obviously likely and possible. Naturally, all such systems and subsystems variations and reconfigurations are to be covered by this Application for patent. For instance:

(a) The computer or processor performing the computations for the determination of the exact location of occurrence of fire may be actually located at the RFFCC rather than at the IDUST itself. In this case, the IDUST simply uplink-transmits its reading of the occurrence of a f/s (say, the coordinate values on its scanner/detector assembly scope, either in terms of the relative coordinates on the ground or simply its screen-readings) to the RFFCC, together with its Identification (ID#).The RFFCC then computes the exact geographical location of the f/s in absolute terms (longitude, latitude) by means of numerical calculations using the SALC-algorithm provided here (see Appendix 2), or by using a look-up table giving the geographical locations of all the IDUSTs against their ID#s, and combining this (location information for the individual IDUST in question) with the relative location data transmitted by the IDUST in question.

(b) The RFFCC may itself act as a major FFCFS, to fight and control FF, in addition to acting as a hub for information transmission (receiving the information about occurrence of FF from one or more IDUSTs and relaying the same to various associated FFCFS in the area.

(c) The IDUST may be permanently fixed on the ground to scan a pre-specified region or sub-region of a forest, or it could be of a mobile type to patrol and monitor the region against fire on a regular or emergency basis, as the need arises. The mobile type of IDUST (that is, the scanner/detector/GPS/microprocessor or computer assembly onboard a patrol vehicle on the ground or in air, on a regular or emergency basis) may be suitable in certain special cases where no permanently fixed towers on ground exist, or where building or erecting one may be impractical due to intractable terrain or prohibitive economic cost. On the other hand, wherever the terrain and the economy permits, IDUSTs may be erected on the top of a high-level point (hillock, hill or mountain peak) in order to allow a maximum area-coverage and visibility of the forest region by virtue of the high altitude afforded naturally. Note that, in any case, the ‘effective height’ of the IDUST should be taken with respect to the sea-level. A relationship between the ‘effective height’ of the IDUST and the maximum distance (range) as well as area covered by it, considering the spherical Earth's surface geometry, is provided in Appendix 1 of this Application for patent.

(d) The satellite system could be replaced or augmented by a terrestrial wireless network, as already mentioned. Further, the functions of the IDUST-uplink transmitter, satellite uplink-and-downlink transmitters and RFFCC could also be performed, at least in part, by the wireless network should the local network, terrain and various other relevant factors permit such expanded operation of the wireless network.

(e) The SSWAS subsystem, introduced here as an independent invention applied to the FFiCS, for better efficiency and economy of transmit-power, as described below, may be replaced by the conventional antenna serving the telecommunications links. In any case, a detailed calculation of the performance of the communications link (‘uplink’ and ‘downlink’ signal-to-noise ratio (S/N) and the achievable energy-per-bit to noise-density ratio (Eb/No)) must be performed to ensure correct (reliable and accurate) data-transfer function by the telecommunications link(s). If necessary, coding and decoding scheme(s) may be employed in these links, as necessary. Various trade-offs for the link performance and optimization, as is the usual practice in the satellite/wireless industry and subject to the state-of-the-art could and should be utilized. In particular, this involves careful consideration of the economic construction, installation, operation, maintenance, and upgrade of the IDUST and SSWAS assembly, choice of the satellite vs. wireless (or hybrid) link and the choice of the satellite itself, electromagnetic interference from and to other systems; regulatory provisions and procedures, and so on.

(e) If installation of IDUSTs within the forest region with a scanner scanning a full (360-degree) coverage is not practical because of intractable terrain, impenetrable foliage, high economic costs, or other reasons, or if a scanner with full scanning is not required due to its location, the IDUSTS could be provided at least at the boundary of the forest region (scanning with a 180-degree coverage, for example) to protect the forest region within the boundary, thereby to particularly protect residential areas just outside this boundary. The safeguard of the residential area in the immediate vicinity of the forest region could thus be assured by a preventive measure for fire control to be already in place, and also through early enough warning to the RFFCC for containing the fire and, if necessary, for evacuation by the residents in case the fire still assumes a larger proportion.

Other major or minor variations of the generic systems configuration are clearly possible and might become feasible with future technological advances; and such obvious variations are therefore also to be covered by this Application for patent for ForeFiCS (FFiCS.) The basic features and the essential functionalities of the main components and subsystems involved in the FFiCS, for which this Application for patent is being filed, are briefly outlined in the following section.

### The Ignition Detector and Uplink Signaling Tower (IDUST)

The basic function, design and operation of an IDUST comprise a Scanner and Detector System (SDS) for detecting the occurrence of the initial flame/smoke/sparks (f/s), a Scanner-based Accurate Location Calculator (SALC), and an Uplink Signaling System (USS) using a Super-Efficient Satellite/Wireless Antenna System (SSWAS). These subsystems and associated functionalities are succinctly described below.

### Scanner

A particular IDUST is designated to continually scan a specific region or sub-region of the forest, either in a Fixed mode or in a Periodic Sweep mode. In a simplest and crude implementation, use could be made of one or more static or revolving digital ‘still’ and/or video camera and/or closed-circuit television (CCTV), and/or similar other devices, covering the entire designated forest region at once (in the Fixed mode) or partially at one time so as to provide full coverage in each cycle of scanning (in the Periodic Sweep mode.) In either mode of operation, the field of view (forest region or sub-region) is accurately mapped on to the monitor performing the scanning function with a sufficiently high resolution. For instance, for an IDUST of height 350 feet, if a still digital camera with 100 mega-pixels is designed to cover 1 million acres of the forest region (in the Fixed mode or for a particular position of the Periodic Sweep mode, see Table 1 of Appendix 1), then each single pixel covers (i.e., can be associated with)

(4840×9×10⁶)/(100×10⁶)=435.6 square-feet/pixel.

The above area (covered by each pixel) is approximately equivalent to a square of side

20.9 feet≈7 yards (i.e., 6.36 meters).

A high enough degree of resolution is obviously required to determines with great precision the actual location of the f/s, so that the exact spot of occurrence can be identified in terms of its geographical latitude and longitude and the fire-prevention and control crew and equipment be dispatched immediately to zero-in, and put out the fire before it escalates at all. The limiting value of fixed viewing or scanning resolution is when one segment of the forest region viewed or scanned corresponds to a few pixels of the scanning device and can therefore be identified uniquely through an accurate mapping of the region of interest over the full screen of the scanner.

For an advanced scanning system, applicable for terrain-related, residential situation or other special circumstances, a few measures of enhancement for the scanner could be incorporated, including, but not limited to, telescopic observation and synchronous array of IDUSTs. The telescopic observation makes use of a telescope of appropriate magnification and range which enhances the field of view; while the IDUST-array system provides similar enhancement by synchronously combining the signal from two or more IDUSTs. These types of enhancements are obviously subject to feasibility and cost-benefit factors, as well as the degree of vulnerability of the selected forest region to occurrence of fires. Furthermore, in addition to performing a scanning of the horizontal level of the region (roughly corresponding to, say, the average or median height of trees in the region), the telescopic device could be used to scan the vertical dimension of the forest region, especially if and when the horizontal scanning indicates a high probability of occurrence of f/s, so as to reconfirm such an occurrence and to provide additional data useful toward the its exact location and degree and size of the fire. Clearly, the telescopic surveillance, being performed routinely or being switched on upon indication of occurrence of fire from horizontal level surveillance, should be capable of detecting the fire through optical and infra-red range of the spectrum, including special provision for detecting smoke distributed in the vertical direction above the trees.

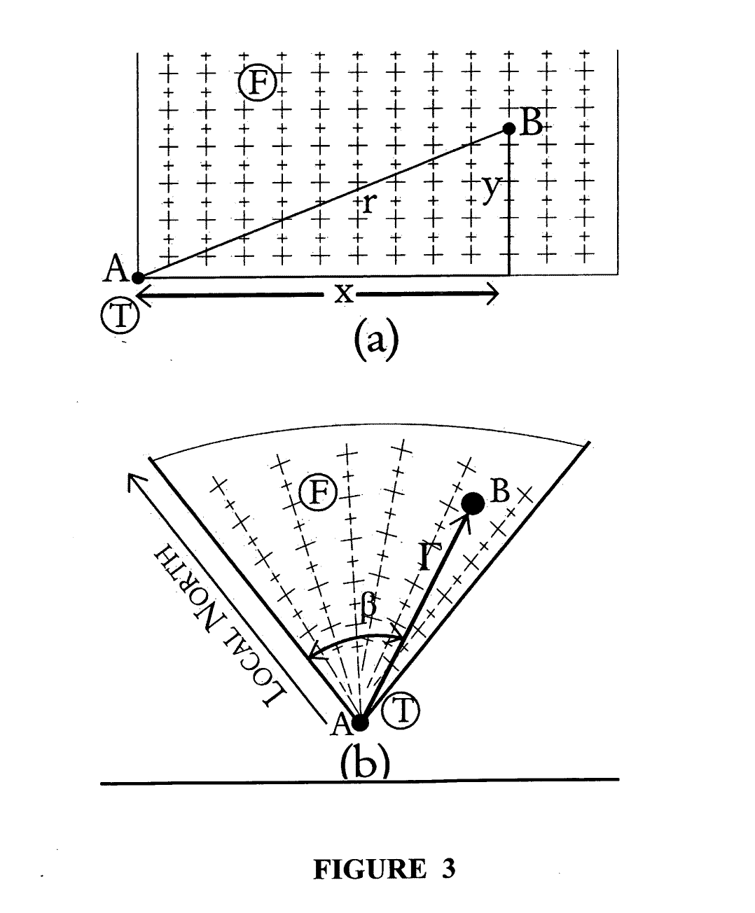

Depending on the requirements and the location of the IDUST, the Scanner performs the scanning of the region over a specified angular range that may vary from 360-degrees to 180-degrees (or even less, when monitoring a smaller strip of the forest), with the tower as the axis. Rectangular (x,y) or polar (γ,β) pattern of scanning may be implemented, as illustrated in FIG. 3. Also, the IDUST may be a permanently fixed structure (tower) located on the average ground level or, preferably, upon a local hill or mountain peak (for the obvious reason of maximizing the range of visibility); or even a mobile unit, such as a fire-truck, jeep, helicopter or surveillance plane flying over the forest region during emergency operation or routine surveillance. Consequently, the ‘effective height’ of the IDUST may vary over a wide range, say, from a few tens of feet to many thousands of feet, as referred to the sea-level.

The forest region scanning process is similar to a lighthouse guiding ships in the high waters, or to a radar operation in an airport monitoring the skies for incoming and outgoing aircraft, with the essential difference that the f/s is the source of radiation (light and heat, i.e., visible and infrared emission) and smoke to be detected, from direct reception of radiation by the IDUST. In other words, unlike a lighthouse, the IDUST is clearly not the source of radiation; and unlike an airport radar, the operation of the IDUST is not based on receiving the reflected radiation. In particular, for a sweep mode operation, the periodicity for coverage of a given spot should be no more than a few minutes, and ideally should not exceed the time-span a f/s onset takes to spread beyond the area corresponding to the resolution of the scanner.

### Detector

The visible and/or the infrared detector employed in the scanner/detector assembly is of a suitable material providing adequate sensitivity to register any f/s occurring even at the farthest point within the designated coverage region or sub-region of the forest. A flame or even a large cluster of sparks may be visible to a naked human eye across a large distance (a few miles); and state-of-the-art photosensitive and infrared detector materials with far higher sensitivity are commonly available with the present technology. Materials with much higher sensitivity are expected to become available with evolving technology. Clearly, the main factor here is the differential intensity of radiation, in the visible/infrared part of the spectrum, for the f/s spot compared to the intensity of radiation in the surrounding area (background radiation) during day or during night; as it is well-known that all objects, including the trees and shrubs throughout the forest region, always emit (or reflect) infrared (or visible light) radiation in varying proportions—a fact made use of in ordinary as well as the night-vision infrared camera.

The detector materials and devices used in (a) remote-sensing earth-observation satellites, (b) military satellite or surveillance systems (c) radio astronomical observation systems, etc. could be adopted for use for the FFiCS applications. As a large amount of smoke accompanying f/s might cover the flames, detection of smoke itself is crucial for the detector system. The smoke detection may rely on optical and infra-red spectral characteristics of a body of smoke.

For an efficient detector, the selection of the wavelengths for detection of f/s is to be made on the basis of special, state-of-the-art, investigations regarding the typical and most intense radiation from a sample small fire generated by burning in a laboratory the specific types of wood involved. The spectral characteristics of the specific atoms and molecules could be studied for deciding on the best suitable wavelength utilized for constructing the detector for the implementation of the FFiCS.

### Location Determination System

The location determination subsystem of the IDUST consists of two functional elements—the determination of the geographical location of the IDUST itself and, in the event of occurrence of a fire within the designated region covered by it, an accurate determination of the location of the occurrence with respect to the location of the IDUST (that is, in the coordinate frame with the location of the IDUST taken as the reference point or the origin of the local coordinate system.) The two components of location determination are referred here as the Primary Location Determination System (PLDS) and Secondary Location Determination System (SLDS), respectively, with their major functional characteristics as described below.

### PLDS

The Primary Location Determination System (PLDS) basically relies on the use of the Geographical Positioning Satellite (GPS) system collocated with the IDUST, preferably at its base. If and when an f/s is detected by a particular IDUST, it send the relevant information to the RFFCC together with the reading of its location from the GPS. For permanently fixed IDUSTs, as an alternative to sending the PLDS reading from the collocated GPS, the IDUST can simply send its identification number (ID#) to the RFFCC which maintains a complete list of such IDUSTs together with the corresponding geographical location information (i.e., the accurate latitude and longitude of the IDUSTs in question.) This would minimize the information to be transmitted to the RFFCC and help speed up the processing of the information received for expedient action. Note that the PLDS data remains constant in time for a fixed IDUST but would normally be variable for a mobile IDUST mounted on a fire-truck, monitoring jeep, helicopter or other suitable vehicle.

### SLDS

The Secondary Location Determination System (SLDS) can operate on the basis of a Scanner and Accurate Location Calculator (SALC), comprising a pre-calibrated scanner (PCS) or a scanner-cum-calculator (SCC) mode. In the PCS mode, the scanner is calibrated and coded such that if the occurrence of an f/s detected by the detector in course of the scanning process (or under the full view monitoring for a fixed camera, for example), then the particular pixels marking the f/s in the given position of the scanner signal the f/s instantly and automatically recognize and register the corresponding geographical location (values of the latitude and longitude on the ground) in the assigned region of the forest. Such a one-to-one mapping of the forest ground on to the scanner screen (pixels), within the resolution of the scanning and digital camera-type of detector is performed beforehand and the mapping data is stored in a data-base located with each IDUST individually, or collectively for all IDUSTs at the RFFCC. In the SCC mode, the actual geographical location (latitude, longitude) of the exact spot of the occurrence of the f/s detected is computed from the information about the PLDS in conjunction of the scanner reading of local coordinates, by using appropriate formula.

Appendix 1 of this Application for patent provides the requisite formula for the determination of the maximum distance (range) and the total area of coverage for an IDUST of a given height, assuming a spherical Earth surface topology. Appendix 2 provides the formula for the calculation of the latitude and longitude of the spot of occurrence of the f/s based on the information about the IDUST location (latitude, longitude, from the co-located GPS or based on the IDUST-ID#), combined with the scanner reading of the local rectangular (x,y) or polar (γ,β) coordinates (see FIG. 3) of the f/s spot (through a mapping of the ground onto the scanner pixel-assembly) with respect to the IDUST location as the reference point (origin of the coordinate system), again assuming a spherical Earth surface topology. Deviation of the spherical Earth topology due to the irregularities of the local terrain is of course likely, but the resulting inaccuracy in the determination of the f/s location is assessed to be relatively small and negligible for the present purpose. The invention of the Scanner Accurate Location Calculator (SALC) is based on the algorithm developed for the implementation of this formula (Appendix 2.)

The process of the SLDS is enhanced by a suitable, state-of-the-art, picture processing technique (PPT)—such as taking the ratio of the current pixel(s) reading (of the intensity of the selected radiation) and the average of the available readings for the surrounding or the nearest-neighbor pixels or groups of pixels—based on the state-of-the-art PPT might be incorporated. An identification of the pixel(s) for which this ratio is significantly higher than one (1), would then likely indicate the occurrence of f/s at the spot corresponding to the pixels in question; and the location determination process is turned on automatically for such pixels. Alternatively, a comparison could be made of the observed intensity for a given pixel with a standard value of the intensity of radiation for the specific conditions (terrain, weather, time of the day, etc.) in order to identify probable occurrence of a f/s. The picture-processing technique (PPT) and its operational algorithm is embedded in the implementation and interpretation of the scanner reading of the IDUST, and can be adjusted or upgraded directly or remotely. A microprocessor element of the scanner provides the necessary data-base, calculation and PPT functionalities, with flexibility of locating some or all of such calculation and PPT functionalities to be shared with the RFFCC, as dictated by the specific local and regional conditions, cost consideration, etc.

### Uplink Antenna

The uplink signaling and data transmission from an affected IDUST (showing in its scanner reading the occurrence of an f/s) to the RFFCC takes place via a geostationary (GEO) or low-earth orbiting (LEO) satellite covering the region of the IDUST-population for the forest region. This uplink signaling system therefore comprises an uplink antenna atop, or collocated with, the IDUST, pointing to the satellite involved. The combination of the satellite beam (constituted by the satellite receive-antenna) and the IDUST transmit-antenna must be capable of providing a strong enough transmission link to perform the signaling and data transmission process with highest degree of fidelity, accuracy and reliability.

The function of the relay satellite could be alternatively provided by a terrestrial wireless relay tower (or network of towers) offering a clear line-of-sight view to the IDUST and the RFFCC receive antennas. Thus it should be understood that, for the purpose of this Application for patent, although mention may be made of a satellite system for signal transmission from the IDUST to the RFFCC, the description also equivalently applies to the case of use of a suitable wireless relay station performing the same function with comparable performance. A brief description of the associated necessary antenna design for the highest possible antenna gain value for the IDUST, including methods to enhance this (antenna gain or efficiency) value, are summarized in Appendix 3. The antenna gain enhancement method and the associated antenna design presented in this Application for patent of FFiCS comprises another independent invention, called here the Super-Efficient Satellite or Wireless Antenna System (SSWAS) described in more detail in Appendix 3; and this Application includes a claim for SSWAS as an invention by the present inventor. It should be recognized, however, that SSWAS could be implemented in other satellite/wireless applications (not FFiCS) as well, and the present Application is intended to cover all such utilization and implementations of SSWAS.

4.2 The Satellite (and/or Wireless) Relay System (SWRS)

A complete link includes the uplink from the IDUST antenna to the satellite (or wireless tower) and a downlink from the satellite to the RFFCC antenna, of suitable type and size. The transponder in the relay satellite provides the appropriate level of amplification, and the signaling is carried out using the appropriate frequency bandwidth allocated by the Federal Communications Commission (FCC) of the USA or the International Telecommunications Union (ITU), or an equivalent national, international or regional authority, depending on the country or region of operation, in compliance with the coordinated spectrum allocation policy in question. The satellite capacity is leased or purchased by the relevant forest department authority, with reasonable degree of performance and reliability to guarantee a fail-safe signaling of an f/s event with highest degree of fidelity, accuracy and authenticity. Suitable coding-decoding and encryption technique is applied in the signal transmission process to avoid a false alarm or natural or man-made inadvertent or intentional interference or abuse of the FFiCS operation. The actual data amount is small, comprising information about the IDUST ID#, geographical location (latitude, longitude) and the time of occurrence, and possibly other relevant data (temperature, wind direction and speed, humidity, visibility, etc.) generated by a simple weather-meter attached to the IDUST.

### 4.3 The Regional Forest Fire Control Center (RFFCC)

The RFFCC, operates in a manner similar to a small Receive earth station of a satellite (or terrestrial wireless) network, comprising the following basic subsystems and functionalities:
(a) A downlink antenna and receiver to receive the downlink signal;
(b) A demodulator to demodulate and isolate the basic (FFiCS) signal from the downlink carrier frequency;
(c) A decoder to obtain the information bits from the incoming carrier;
(d) A computer or microprocessor system to evaluate and calculate the actual geographic location (using the SALC from the IDUST, as an option, if such computation is to be performed at the RFFCC instead of at the IDUST) and time of occurrence of the f/s accurately, allowing for any processing delay;
(e) Suitable broadcasting means to instantly broadcast the pertinent information and data to all members or nodes of the Forest Fire Control Field Station (FFCFS) Network in the area, via land-line, satellite, wireless, radio and/or other suitable means and media, each member or node of the FFCFS being properly equipped in terms of manpower, vehicles, materials and other means to fight forest fires;
(f) Optionally, also acting as a major member of the FFCFS Network, the RFFCC is itself also equipped with necessary equipment including land- and/or air-borne vehicles, trained personnel, inter-personal communications means (e.g., mobile phones), materials, and other means for fire-fighting. In particular, a helicopter carrying fire-extinguishing materials means may be dedicatedly deployed at the RFFCC for immediate dispatch to, and deployment at, the actual location of occurrence of the f/s, especially to serve for quenching and control of fire at a large distant or at locations that might prohibits access by land-based vehicle. Such a provision is expected to extinguish the f/s before it has time to spread into a large area or beyond control. It is estimated that any spot in a forest region could be accessed by one means or another within about 20 minutes.

### Appendix 1

### Range of Visibility for an IDUST

This Appendix provides a method of determining the range (the maximum distance) that may be covered (i.e., that may become ‘visible’, using optical or infrared detector) for a Tower of given height, assuming the Earth's surface to be spherical, thereby allowing visibility up to the local horizon.

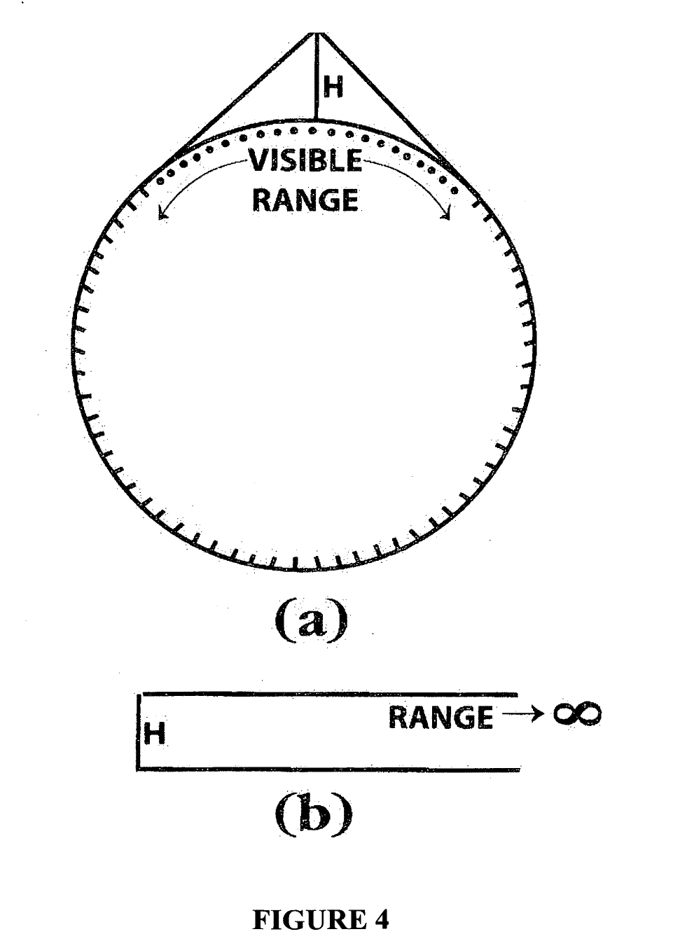

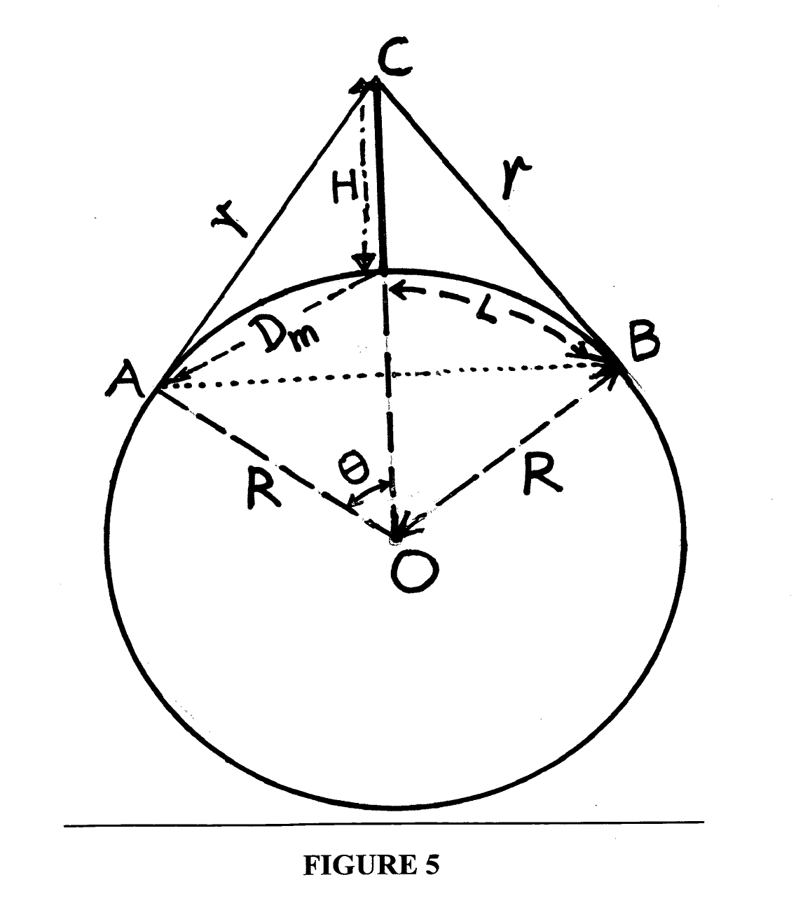

It must be noted that the local terrain may depart from a strictly spherical geometry for the Earth's surface in the region of interest, with mountains, hills, hillocks, valleys, and other topological features acting the sources of departure from strict spherical shape of the Earth's surface in the forest region. Hence the present calculations and numerical results might need to be somewhat modified based on the local topography. However, the spherical surface assumption for the Earth as a whole is a general and reasonable one even for the present approximate calculation of the value of the range for an IDUST (“Tower”). Furthermore, it may be assumed that the Tower is erected at the top of a highest accessible point locally—say at the peak of a mountain, hill or hillock, if any, within the region. Thus the term ‘effective height of the Tower’ would accordingly be taken as the altitude of the top of the Tower from the sea-level taken as a general reference, unless a significant reevaluation of the value of the height is warranted due to unusual local topographical features. In general, limitation in the range, i.e., in the maximum distance of ‘visibility’ (using optical or infrared or any other suitable radiation wavelength), essentially arises due to a curvature of the Earth's surface, since a flat-Earth topology would, in principle, allow an infinite range for a Tower with its top even slightly above the flat envelope of the tree-tops in the forest within the region; see FIG. 4. For an estimation of the value of the range, refer to FIG. 5, with the notations and symbols as indicated therein; viz.

Notations and Symbols:
O—Center of the Earth
R=Radius of the spherical Earth (i.e., OA=OB=R)
H=Effective height of the Tower at the Point A (i.e., AC=H)
CB—Tangent from C (i.e., Angle OBC=90°=π/2 radians)
r=Length of the Tangent (i.e., CB=r)
θ=Angle AOB
Dm=The Range as measured by the Chord (Straight Line) AB
L=The Range as measured by the Arc-Length (Curved Line) AB

Clearly,

$$θ = {Cos}^{- 1} ( \frac{R}{R + H} )$$

$$and$$

$$L = R θ$$

$$also$$

$${D}_{m} = 2 R Sin ( \frac{θ}{2} )$$

$$Since$$

$$Cos θ = 1 - 2 {Sin}^{2} ( \frac{θ}{2} )$$

$$\frac{R}{R + H} = 1 - 2 {( \frac{{D}_{m}}{2 R} )}^{2}$$

$${D}_{m} = R \sqrt{( \frac{2 H}{R + H} )} \approx \sqrt{2 R H} , [ ∵ H ≪ R ]$$

$$Sin \frac{θ}{2} \approx \frac{θ}{2} \approx \frac{{D}_{m}}{2 R}$$

$$L = R θ \approx {D}_{m} \approx \sqrt{2 R H}$$

The above formula can be used to determine the approximate value of the range (L≈Dₘ).

The area, A, of the forest region covered by the IDUST can be simply written as

A≈π(Dₘ)²≈2πRH

The above expression for the area (A) is considering the curvature of the earth's surface to be negligible; that is, it represents the approximate value of the area based on a flat earth approximation, allowing the area to be given as that of a circle of radius Dₘ in a plane at the base of the IDUST and perpendicular to it (assuming deviations due to the local topology to be negligible)—a fairly satisfactory approximation in most cases with moderate value of the height H. Using the numerical values

R≈3956.66 miles=the mean radius of the Earth,

and the conversion factors

1 mile=1760 yards=5280 feet,

1 acre=4840 square yards,

i.e., 1 square mile=640.5 acres,

the following approximate expressions are obtained:

Dm≈L≈\sqrt{2RH}≈1.224\sqrt{H′}(miles)

and

A≈4.708H′(square-miles)

where H′ in the preceding expressions for the length and area is in feet. Also, it is easy to verify that the decrease in the estimated values of Dm and L due to the flat Earth approximation is 0.0012%, and the decrease in the value of area A is 0.0024%. The above approximations are therefore fairly satisfactory for all practical purposes.

A few sample numerical values of the range (Dₘ)) and the area of coverage (A) for an IDUST of height H are shown in Table 1. The smallest value in fact can be taken as the distance to the horizon as seen by a person of height of 5′; while the high values (say H>500′) could be considered to be the range visible by a pilot of a helicopter or plane flying over the forest region. The general variation pattern of the range and area of visibility as functions of the height H of the Tower is illustrated in the plot of Figure A3. As is to be expected, the area increases linearly with the height of the IDUST, increase in the height H by 1 foot increases the area of visibility by about 4.7 square-miles.

TABLE 1
SAMPLE VALUES OF THE RANGE (Dₘ) AND AREA(A)

| | ARC- | | |
|---|---|---|---|
| | LENGTH (L) ≅ | | |
| IDUST HEGHT (H) | CHORD (Dm) | AREA (A) | AREA (A) |
| (feet) | (miles) | (Square-miles) | (Acres) |
| 5 | 2.737 | 23.5 | 15,077.4 |
| 25 | 6.120 | 117.7 | 75,386.9 |
| 50 | 8.655 | 235.4 | 150,773.7 |
| 100 | 12.240 | 470.8 | 301,547.4 |
| 150 | 14.991 | 706.2 | 452,321.1 |
| 200 | 17.310 | 941.6 | 603,094.8 |
| 250 | 19.353 | 1,177.0 | 753,868.5 |
| 300 | 21.200 | 1,412.4 | 904,642.2 |
| 350 | 22.899 | 1,647.8 | 1,055,415.9 |
| 400 | 24.480 | 1,883.2 | 1,206,189.6 |
| 500 | 27,369 | 2,354.0 | 1,507,737.0 |
| 600 | 29.981 | 2,824.8 | 1,809,284.4 |
| 700 | 32.384 | 3,295.6 | 2,110,831.8 |
| 800 | 34.620 | 3,766.4 | 2,412,379.2 |
| 900 | 36.720 | 4,237.2 | 2,713,926.6 |
| 1,000 | 38.706 | 4,708.0 | 3,015,474.0 |
| 2,000 | 54.739 | 9,416.0 | 6,030,948.0 |
| 3,000 | 67.041 | 14,124.0 | 9,046,422.0 |
| 5,000 | 86.550 | 23,540.0 | 15,077,370.0 |
| 10,000 | 122.400 | 47,080.0 | 30,154,740.0 |

### Appendix 2

### Accurate Determination of the Geographical Location of Forest Fire

In this Appendix, the problem of an accurate determination of the geographical location of the fire is addressed. The success of the FFICS critically depends on a precise determination of the exact location of the occurrence of the initial flames, smoke and sparks (f/s) of the fire, so as to enable the means (fire-fighting crew or air-borne vehicle) of fire control to arrive at the location early enough to quench it, before the fire has a chance to spread over a wide area. Here a formulation of the exact geographical location (latitude, longitude) of the f/s is presented. This formulation is based on the determination of the location of the f/s with respect to the location of the IDUST that detects it, assuming that the exact geographical location (latitude, longitude) of the IDUST in question is known with the help of a collocated Geo-Positioning System (GPS), or already registered with the Regional Forest Fire Control Center (RFFCC). The relative position of the f/s with respect to the IDUST is assumed to be given in terms of the local rectangular coordinates (x,y) or, equivalently, the polar coordinates (γ,β), of the f/s with the base of the IDUST taken as the origin (see FIG. 3). Since the exact location of the f/s is of paramount and critical importance, its more exact determination based on the curved (spherical) Earth's surface in the vicinity of the IDUST will be employed here.

Let
(λ,φ)=(latitude, longitude) of the base of the IDUST which detect the f/s
(λ′,φ′)=(latitude, longitude) of the location of the f/s
(γ,β)=the polar coordinates of the f/s with respect to the base of the IDUST

It is assumed that (γ,β) is measured by the scanner mounted on the IDUST so that γ denotes the radial distance (i.e., the arc-length on the curved Earth's surface) of the f/s from the base of the IDUST, and β represents the angle the direction of this radial distance makes with the local North (meridian) at the base of the IDUST.

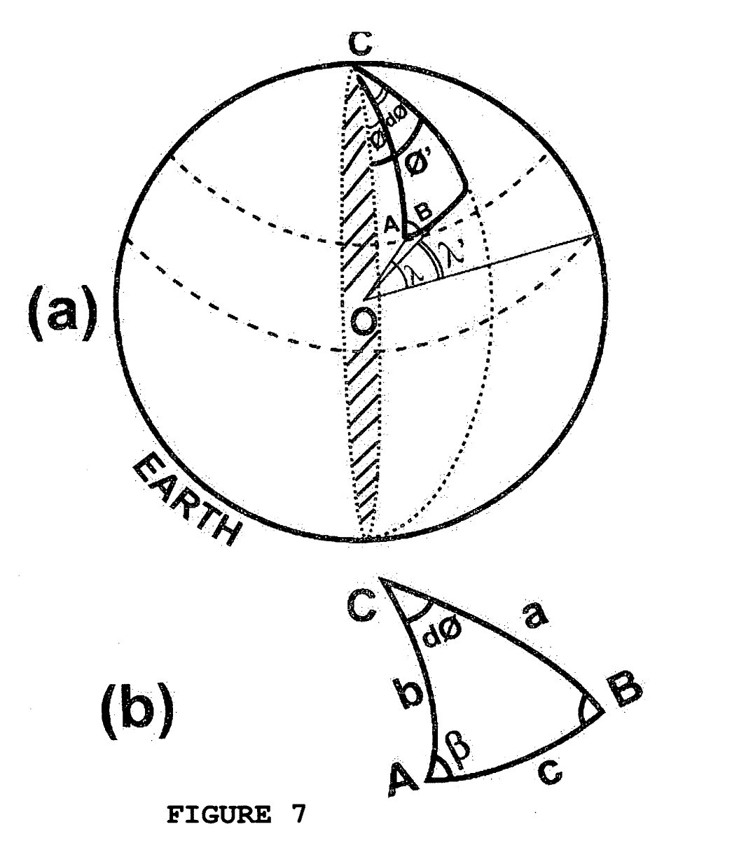

The spherical geometry of the system is depicted in FIG. 7(a) for the Earth as a whole, and in FIG. 7(b) in more detail for the three points of interest for the present purpose; viz.

Point A: the location of the base of the IDUST, with ([latitude, longitude)=(λ,φ)]

Point B: the location of the f/s, [with (latitude, longitude)=(λ′,φ′)], to be determined.

Point C: the North-pole (latitude=π/2)

By definition, AC represents the direction of the local North at the point A, and BC similarly represents the direction of the local North at the point B; and in the spherical triangle ABC, the three spherical angles, A, B, and C, and the corresponding three spherical ‘sides’ (defined as the angle substituted by the arc at the center of the sphere, i.e., at the center of the Earth), a, b, and c, can be written as follows (see, for example, Mathematical Handbook for Scientists and Engineers by Granino A. Korn and Teresa M. Korn, McGraw Hill Book Co., New York, 1968, p. 891):

Angle A=/β; Angle C=dφ(say);

a=π/2−λ′; b=π/2−λ; and c=γ/R,

(R=Radius of the Earth).

It should be noted that if the relative distance of the f/s is measured by the scanner from the top of the IDUST, giving a value γ′ (say), then, clearly, γ=\sqrt{(γ′)²−(H)²}

Using now the ‘Law of Cosine for sides’, one can write:

Cos(a)=Cos(b)Cos(c)+Sin(b)Sine(c)Cos(A),

And from the ‘Law of Sine’,

$$\frac{Sin ( a )}{Sin ( A )} = \frac{Sin ( b )}{Sin ( B )} = \frac{Sin ( c )}{Sin ( C )}$$

Here, remembering that the latitude of a point is the complement of its polar angle, the ‘Law of Cosine for the sides’ yields the relation:

$$Sin ( \frac{π}{2} - a ) = Sin ( \frac{π}{2} - b ) Cos ( \frac{γ}{R} ) + Cos ( \frac{π}{2} - b ) Sin ( \frac{γ}{R} ) Cos A$$

$$i . e . , \\ Sin ( {λ}^{′} ) = Sin ( λ ) Cos ( \frac{γ}{R} ) + Cos ( γ ) Sin ( \frac{γ}{R} ) Cos ( β )$$

$$and$$

$$Sin ( C ) = \frac{Sin ( c ) Sin ( A )}{Cos ( \frac{π}{2} - a )}$$

$$i . e . , \\ Sin ( d φ ) = \frac{Sin ( \frac{γ}{R} ) Sin ( β )}{Cos ( {λ}^{′} )}$$

$$Consequently , \\ {λ}^{′} = {Sin}^{- 1} [ Sin ( λ ) Cos ( \frac{γ}{R} ) + Cos ( λ ) Sin ( \frac{γ}{R} ) Cos ( β ) ]$$

$$and$$

$${φ}^{′} = φ + {Sin}^{- 1} [ \frac{Sin ( \frac{γ}{R} ) Sin ( β )}{Cos ( {λ}^{′} )} ]$$

The last equation follows from the obvious relation: φ′=φ+dφ, for the longitude (Note that the proper algebraic sign, +oe−, must be carefully retained in order to get the correct values). From above, the unknown geographical location, i.e., the latitude and longitude (λ′ and φ′, respectively) of the point of f/s is calculable exactly from the known parameters (the latitude and longitude, λ and φ, respectively, of the base of the IDUST, determined with the help of a collocated GPS), and the relative polar coordinates, γ and β, respectively, of the location of the f/s with respect to the IDUST location.

### Appendix 3

### Super-Efficient Satellite or Wireless Antenna System (SSWAS)

In a satellite (or wireless) communications system, the transmitter and receiver are attached to the transmitting and receiving antennas, respectively. The antennas are typically of the offset parabolic reflector type, with the reflector surface generated by revolution of a parabola about its axis, and the transmitting and receiving elements (feeds) located at the focus of the parabola. This reflector geometry concentrates the received field due to a far-away transmitting antenna, tantamount to a uniform field (symbolically represented by a set of parallel field-lines) on to the focus of the receiving antenna; while at the transmitting antenna, the feed at the focus provides an outgoing field that can be considered as a uniform field, symbolically represented as a set of parallel field-lines. This is because, according to the Law of Reflection in optics (‘The angle of reflection is equal to the angle of incidence”), a ray parallel to the axis of the parabola must pass through the focus of the parabola. The transmitted electromagnetic field, at the aperture of the transmitting antenna, is called the ‘Primary’ field distribution, while the received field, at the aperture of the receiving antenna, is called the ‘Secondary’ field distribution.

It is well-known that the Secondary field (S) is the Fourier transform of the Primary field (P). It is a common practice in satellite and wireless communication engineering to design antennas such that the P-field is uniform (over the aperture of the transmitting antenna.) The Fourier transform of a uniform function is a sinc-function, of the form [Sin(x)/x], which typically has a central peak, forming the main antenna coverage beam (also termed as the main-lobe’), together with a series of progressively decreasing peaks on both sides of the main-lobe, called the ‘side-lobes’ (see, for example, ‘Satellite Communications Systems’ by M. Richharia, McGraw Hill Book Co., New York, 1999, p. 96.) It is the main beam that is utilized for the communications link, while the side-lobes act as source of interference to neighboring coverage regions of other systems. The side-lobes also represent wasted energy for the system, since the electromagnetic energy contained therein is not utilized for the desired communications link. Thus the existence of the side-lobes is doubly harmful for the system, because they diminish useful energy or desired signal strength, while, at the same time, they increase the overall level of interference-noise among separate systems. Often, careful analysis and observation is devoted in satellite design to maximize the main-lobe strength or the peak-amplitude and to minimize the side-lobe amplitudes. However, there is a simple technique to accomplish the above design goal optimally which apparently has not been recognized in the antenna industry. It is the purpose of the present Invention (SSWAS) to introduce an antenna design comprising this simple technique, as outlined below. Theoretically, the SSWAS should permit a 100% utilization of the transmitted electromagnetic energy to generate the received signal, while reducing the interference to nil. In other words, the received beam for a pair transmitting and receiving antennas designed consistent with the SSWAS technology should provide only the main-lobe, without any side-lobes at all. In practice, minor deviation from this ideal scenario due to imperfections of the reflector surface tolerance and finite size of the feed, turbulence in the intervening medium (between the transmitting antenna and the receiving antenna), etc., might be manifested in less than 100% efficiency, but it is expected that such antennas provide far superior efficiency than available from antennas designed according to the current practice in the industry.

The basic principle behind the design of the SSWAS, simply stated, is to devise the Primary field distribution according to the sinc-distribution pattern. Since the Fourier transform of the sinc-function is a uniform distribution, the resulting Secondary field distribution is uniform, with a single rectangular peak (a main-lobe with no side-lobes.) The net result is that:
(a) Almost all the electromagnetic energy practically becomes available for useful communications, without any wastage, since there are no side-lobes (in a uniform Secondary field distribution); and
(b) The amount of interference to neighboring systems is minimized, due to absence of side-lobes.

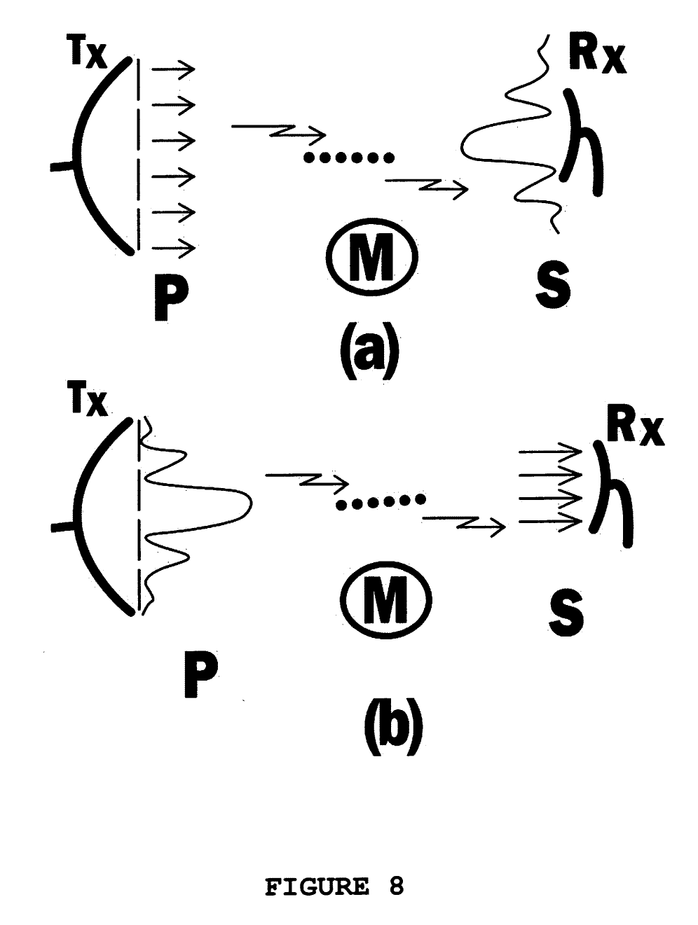

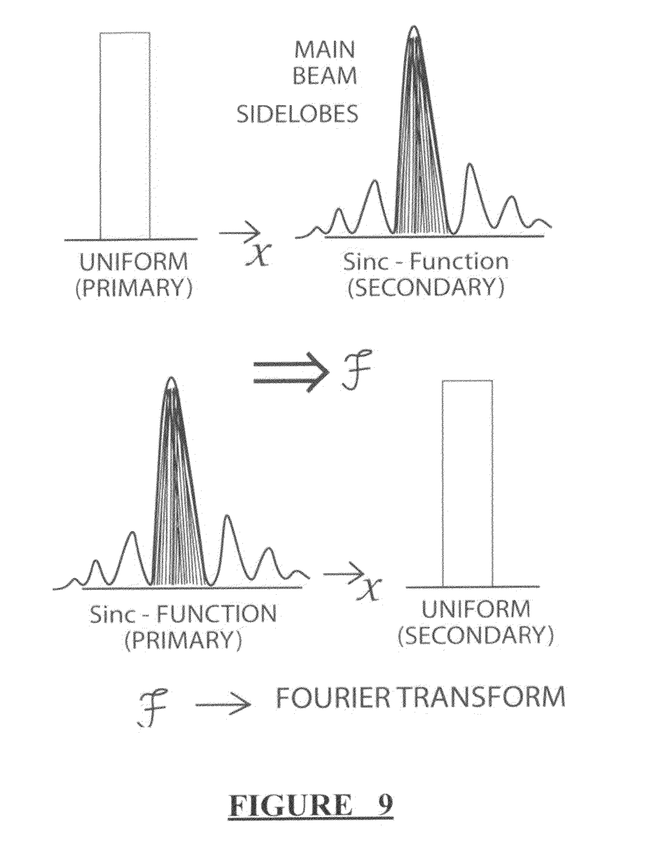

The basic concept of the design of the SSWAS antenna reflector and feed assembly is schematically represented in FIG. 8. FIG. 9 depicts the graphical representations of the uniform (rectangular) and sinc-functions which are Fourier transforms of each other (see, for example, Mathematical Handbook for Scientists and Engineers by Granino A. Korn and Teresa M. Korn, McGraw Hill Book Co., New York, 1968, p. 903). Indeed, this simple mathematical relationship forms the essential basis of this Invention (SSWAS) by the Inventor of FFiCS.

The implementation of the antenna reflector-and-feed assembly design to achieve the stated objective (viz., generation of a sinc-function type Primary field distribution at the aperture of the transmitting antenna) could be accomplished by means of any of many approaches and technologies currently available or could become practical with evolving technology. A few typical relevant approaches are mentioned below:
phase-array antenna technology (suitable design of the amplitudes and phases of the feed elements;
strip feed design;
microprocessor-based control of the Primary field distribution;
structural modification in the reflector geometry, including mesh antenna design;
systematic elective enhancement and suppression of the aperture-field to create the sinc-function type distribution.

It is intended that all such technologies adopted to produce a SSWAS antenna be included in the Claim for the SSWAS as an improved antenna design in the satellite and wireless telecommunications industry (Claim 5)

The present Application is intended to cover all three of the Inventions—FFiCS, SALC and SSWAS—as outlined above in this Application for patent of the said Inventions. The SALC and SSWAS are described above as components of the FFiCS toward early detection of forest fires and control thereof. However, applications of the SALC and the SSWAS Inventions in other areas are obviously conceivable and anticipated. For instance, the SALC could be utilized in conjunction with the conventional GPS system for a more accurate location determination of remote locations (where the GPS itself could not be directly placed due to terrain or other problems.) Similarly, the SSWAS could be utilized in satellite and wireless telecommunications networks, for optimization of the network performance and cost, for applications other than control and prevention of forest fires. Regardless of the specific application or field involved, the Inventions SALC and SSWAS are intended to be universally protected as independent Inventions (useable for FFiCS as well as other purposes) under the relevant Claims of this Application for patent.

### Abbreviations and Acronyms

AP—Associated Press

AP-R—Associated Press Report

CCTV—Closed-Circuit Television

FCC—Federal Communications Commission

FF—Forest Fire

FFiCS (or ForeFiCS)—Forest Fire Control System

FFCFS—Forest Fire Control Field Station

f/s—(Initial) flame(s), smoke and sparks

IDUST—Ignition Detector and Uplink Signaling Tower

ITU—International Telecommunications Union

GEO—Geosynchronous Earth Orbit (Satellite)

GPS—Global Positioning System

IFI—Index of Fire Intensity

LEO—Low Earth Orbit (Satellite)

PCS—Pre-Calibrated Scanner

PLDS—Primary Location Determination System

PPT—Picture Processing Techniques

RFFCC—Regional Forest Fire Control Center

SALC—Scanner and Acuurate Location Calculator

SCC—Scanner-cum-Calculator

SDA—Scanner and Detector Assembly

sinc(x)—[Sin(x)/x]-type Function

SLDS—Secondary Location Determination System

SOIRD—Scanner and Optical and Infrared Radiation Detector

SSWAS—Super-efficient Satellite or Wireless Antenna System

SWRS—Satellite and/or Wireless Relay System

### DIAGRAMS AND DRAWINGS

A list of Figures and Diagrams referred to above in this Application for patent for FFiCS, SALC, and SSWAS, with Claims specified above (Section 5), is provided below, followed by the referred Figures and Diagrams.

FIG. 1—OVERVIEW OF FFiCS [Legend: F—Forest; T—IDUST; Sc—Scanner; S—Satellite; R—RFFCS; H—Housing Complex; f/s—Flames, sparks and smoke; S_{L}—Satellite Link; W_{L}—Wireless Link.

FIG. 2—GENERAL SCHEME OF FFiCS OPERATION

FIG. 3—SCANNING PATTERNS

[a] Rectangular Coordinates (x,y); [b] Polar Coordinates (γ,β)

FIG. 4—RANGE (a) Limited Range (of Visibility) for the Spherical Earth Geometry; (b) Theoretically an Infinite Range for a Flat Earth Geometry.

FIG. 5—THE GEOMETRY OF THE EARTH′S SURFACE in the Forest Region of Interest for Estimation of the Range.

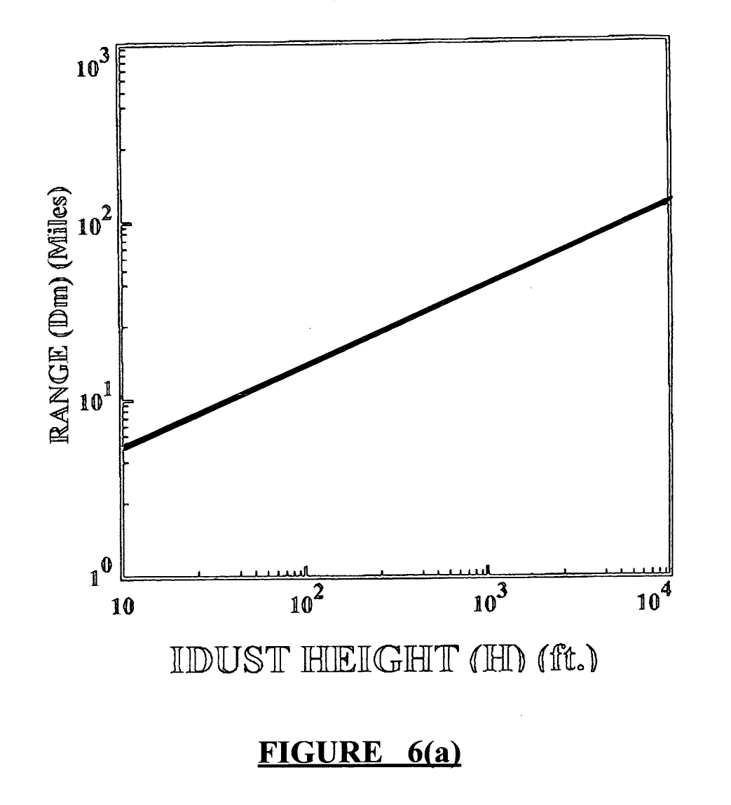

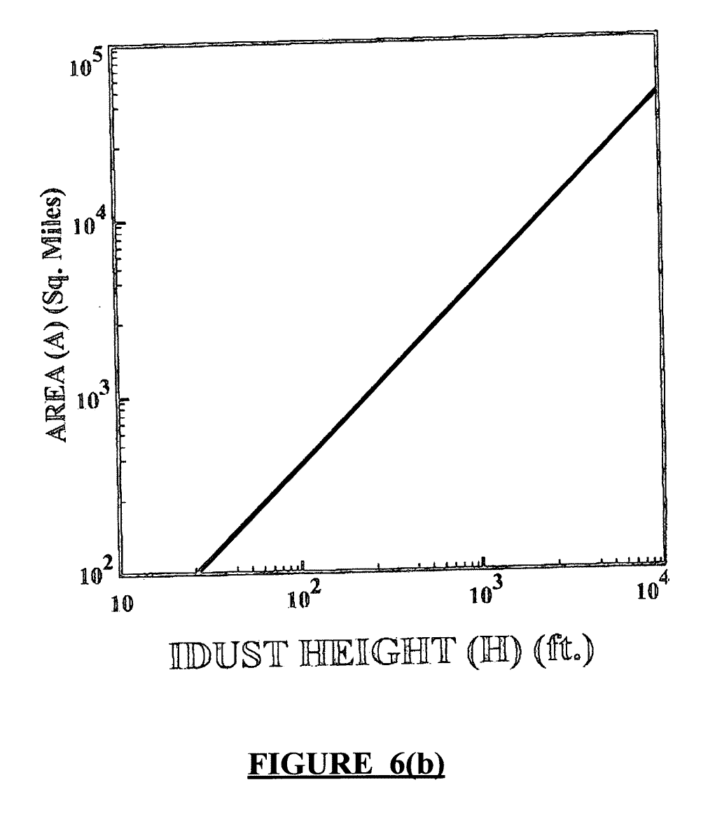

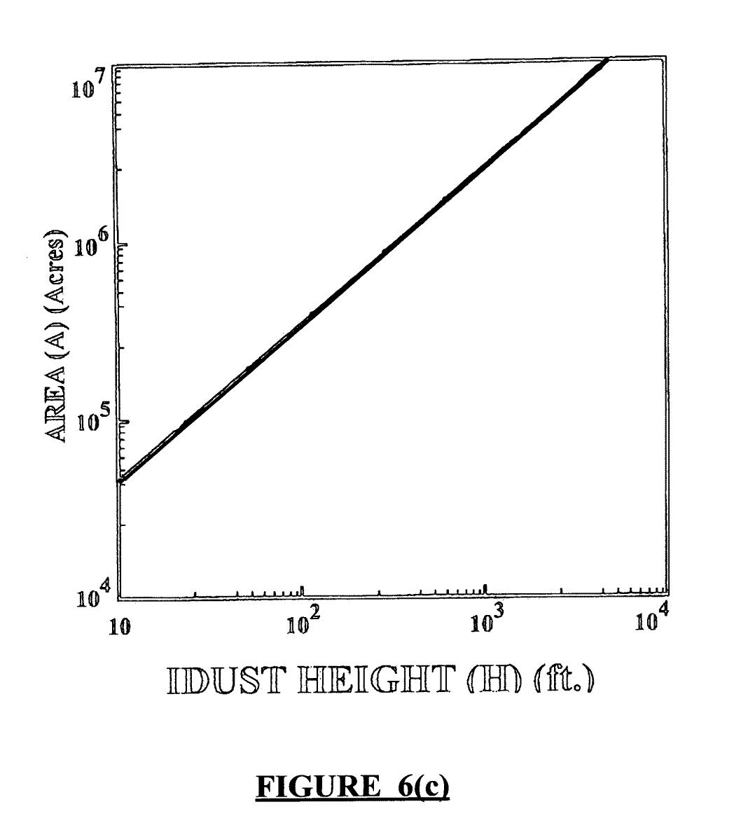

FIG. 6—VARIATION OF THE RANGE (DM) AND AREA OF COVERAGE (A) WITH THE HEIGHT (H) OF THE IDUST.

(Note that the Height (H) is in feet, the Range (Dₘ) is in miles, and the Area (A) is shown in square-miles and in acres, with the respective scales as indicated on the right (for Dₘ) and left (for A) Vertical Axes.)

FIG. 7—THE GEOMETRY OF THE LOCATION OF THE IDUST (at A) AND f/s (at B) [a] On The Earth's Surface; [b] The Spherical Triangle ABC.

FIG. 8—THE ANTENNA PATTERN VARIATION

FIG. 9—THE BASIC COCEPT OF THE SSWAS.

What is claimed is:

1) An automated preventive Forest Fire Control System (ForeFiCS or FFiCS) for prevention and control of forest fires (FF), comprising subsystems and components as described and claimed herein, for early detection of FF and information transmission network via efficient telecommunications means toward expeditious quenching and control of FF before it grows.

2) A spectrally sensitive Scanner and Optical and Infrared Radiation Detector (SOIRD) assembly means for providing digital video or similar detection and imaging of the very initial flames or smoke and sparks (f/s), instantly when it occurs, by means of a continuous observation or rapid periodic scanning of the forest region; the earliest possible detection of the f/s that could potentially grow into, and spread to cause, a FF is the essential key factor in the design and operation of the FFiCS claimed herein.

3) A system of (fire-proof) Fixed or Mobile, Ignition Detection and Uplink Signaling Towers (IDUST), with the SOIRD assembly of claim 2 deployed at its top, allowing an unobstructed view of the region of the forest it is designated to continually monitor or scan.

4) A Scanning and Accurate Location Calculator (SALC) means comprising a preprogrammed microprocessor or computing facility, or an equivalent thereof, for the determination of the exact geographical location (latitude, longitude) and time of the onset of an f/s according to the algorithm provided in this Application or a similarly prescribed method, applied to the reading of a Global Positioning System (GPS) collocated with the IDUST of claim 3 or equivalent prior information about its location. Note that the use of SALC may be optional depending on the adequacy of the GPS data in pin-pointing the exact location of the f/s within the field of view of a given IDUST.

5) An Independent Claim for the SALC as an ancillary device, operating as an enhancement of the GPS, for an accurate determination of the geographical location of a remote point around the physical location of the GPS—the remote point being either inaccessible by the GPS-user (but within his or her field of view or range) or a hypothetical point with a specified range and orientation with respect to the GPS. The SALC device could be used in conjunction with the GPS, or be integrated with the GPS, for many diverse applications other than the FFiCS application.

6) A Super-Efficient Satellite or Wireless Antenna System (SSWAS) means, capable of generating a narrow, uniform beam (‘main-lobe,’ with no or a minimal of ‘side-lobes’) and of being deployed atop (or collocated with) the IDUST of claim 3, and of working in concert with an efficient, economic and reliable communications means, comprising, but not limited to, a geostationary (GEO) or low-earth orbit (LEO) satellite or a wireless network or a landline connection, or a hybrid combination of thereof, for automatically and instantaneously transmitting the data related to an occurrence of f/s, to a Regional Forest Fire Control Center (RFFCC), and thence immediately to a network of Forest Fire Control Field Stations (FFCFSs). Such automated and efficient data and information transmission, without losing any time after an early detection of f/s, is deemed crucial for an expeditious deployment of manpower, machinery, and vehicles including fire-engines and fire-trucks, helicopters, aircraft, etc., together with suitable fire-retardant chemicals and other suitable means and materials, for quickly and efficiently quenching the f/s before it has a chance to grow, thereby preventing and effectively controlling the FF. Note that the use of SSWAS may be optional depending on the efficiency of the antenna system involved for FFiCS application.

7) An Independent Claim for the SSWAS for diverse potential applications for enhanced efficiency of antennas in telecommunications networks other than the FFiCS application.

8) An Independent Claim for the SOIRD for enhanced monitoring and detection process of border areas and selected regions using optical and infrared spectral wavelength radiation, for diverse potential applications other than the FFiCS application.

9) An Independent Claim for the IDUST-type Towers for enhanced monitoring and detection process of border areas and selected regions using appropriate observation, monitoring and imaging means, for diverse potential applications other than the FFiCS application.
